(19) United States
(12) Patent Application Publication
(10) Pub. No.: US 2015/0194181 A1
(43) Pub. Date: Jul. 9, 2015

(54) SPINDLE MOTOR AND HARD DISK DRIVE INCLUDING THE SAME

(71) Applicant: SAMSUNG ELECTRO-MECHANICS CO., LTD., Suwon-Si (KR)

(72) Inventor: Dong Hyun LEE, Suwon-Si (KR)

(73) Assignee: SAMSUNG ELECTRO-MECHANICS CO., LTD., Suwon-Si (KR)

(21) Appl. No.: 14/590,964

(22) Filed: Jan. 6, 2015

(30) Foreign Application Priority Data
Jan. 7, 2014 (KR) 10-2014-0001826

(51) Int. Cl. G11B 19/20; F16C 32/06

(52) U.S. Cl. CPC G11B 19/2036; F16C 32/0607; F16C 32/0633

(57) ABSTRACT

There is provided a spindle motor including, a lower thrust member including an extension part protruding upwardly; a shaft fixed to the lower thrust member; an upper thrust member extended from an upper end portion of the shaft; and a rotating member disposed above the lower thrust member and rotatably installed on the shaft, wherein an outer surface of the upper thrust member and an inner surface of the rotating member have a first sealing part formed therebetween, the first sealing part having a first liquid-vapor interface formed therein, an inner surface of the extension part of the lower thrust member and an outer surface of the rotating member have a second sealing part formed therebetween, the second sealing part having a second liquid-vapor interface formed therein, and the rotating member includes a communication hole formed therein so as to connect the first and second sealing parts to each other.

### CROSS-REFERENCE TO RELATED APPLICATION

This application claims the benefit of Korean Patent Application No. 10-2014-0001826 filed on Jan. 7, 2014, with the Korean Intellectual Property Office, the disclosure of which is incorporated herein by reference.

### BACKGROUND

The present disclosure relates to a spindle motor and a hard disk drive including the same.

A fixed shaft type spindle motor in which a shaft having strong impact resistance is fixed to a case of a hard disk drive is generally mounted in an information recording and reproducing device, such as a hard disk drive for a server, or the like.

That is, a shaft may be fixedly installed in the spindle motor mounted in the hard disk drive of a server in order to prevent a disk provided thereon from being damaged, and information recorded on the hard disk drive from becoming unreadable, due to external impacts.

Meanwhile, since it is necessary for a spindle motor used in an enterprise hard disk drive to have a high degree of reliability, it is necessary to maintain an amount of lubricating fluid provided in a hydrodynamic bearing assembly including a fixed shaft.

However, at the time of driving the spindle motor, a liquid-vapor interface of the lubricating fluid may rise, such that the lubricating fluid may leak in a direction in which a disk is mounted.

Therefore, due to such leakage, an amount of fluid present in a journal bearing may be reduced to be insufficient, causing rotation characteristics to deteriorate. Further, the disk may be contaminated by the leaked fluid.

### SUMMARY

An aspect of the present disclosure may provide a spindle motor capable of effectively preventing a lubricating fluid from leaking toward an upper interface through a simple structural change, and a hard disk drive including the same.

According to an aspect of the present disclosure, a spindle motor may include: a lower thrust member fixed to a base member and including an extension part protruding upwardly in an axial direction; a shaft fixed to the lower thrust member; an upper thrust member extended from an upper end portion of the shaft in a radial direction; and a rotating member disposed above the lower thrust member and rotatably installed on the shaft, wherein an outer surface of the upper thrust member and an inner surface of the rotating member have a first sealing part formed therebetween in the radial direction, the first sealing part having a first liquid-vapor interface formed therein, an inner surface of the extension part of the lower thrust member and an outer surface of the rotating member have a second sealing part formed therebetween in the radial direction, the second sealing part having a second liquid-vapor interface formed therein, and the rotating member includes a communication hole formed therein so as to connect the first and second sealing parts to each other.

At least a portion of the communication hole may be inclined in an outer diameter direction downwardly in the axial direction.

The communication hole may include a horizontal portion extended from a portion that is in communication with the first sealing part in an outer diameter direction and an inclined part that is in communication with the second sealing part from an outer edge of the horizontal portion in the radial direction and inclined in the outer diameter direction downwardly in the axial direction.

In a state in which the rotating member stops, an inner edge of the communication hole in the radial direction may be positioned above the first liquid-vapor interface in the axial direction, and an outer edge of the communication hole in the radial direction may be positioned above the second liquid-vapor interface in the axial direction.

The inner surface of the rotating member in the radial direction forming the first sealing part may be inclined in an inner diameter direction upwardly in the axial direction.

The outer surface of the upper thrust member in the radial direction forming the first sealing part may be inclined in an inner diameter direction upwardly in the axial direction.

The outer surface of the rotating member in the radial direction forming the second sealing part may be inclined in an inner diameter direction upwardly in the axial direction.

An interval between the inner surface of the rotating member in the radial direction and the outer surface of the upper thrust member in the radial direction that form the first sealing part may be reduced downwardly in the axial direction.

An interval between the outer surface of the rotating member in the radial direction and the inner surface of the extension part in the radial direction that form the second sealing part may be reduced downwardly in the axial direction.

The communication hole may be formed in the radial direction.

A lower end of the first sealing part may be positioned above the second sealing part in the axial direction.

According to another aspect of the present disclosure, a hard disk drive may include: the spindle motor as described above rotating a disk through power applied thereto through a substrate; a magnetic head writing data to and reading data from the disk; and a head transfer part moving the magnetic head to a predetermined position on the disk.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic cross-sectional view illustrating a spindle motor according to an exemplary embodiment of the present disclosure;

FIG. 2 is an enlarged view of part A of FIG. 1;

FIG. 3 is a partially cut-away exploded perspective view illustrating a shaft, a sleeve, and upper and lower thrust members according to an exemplary embodiment of the present disclosure;

FIG. 4 is an enlarged view of another example of part A of FIG. 1; and

FIG. 5 is a schematic cross-sectional view illustrating a recording disk driving device having the spindle motor according to an exemplary embodiment of the present disclosure mounted therein.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

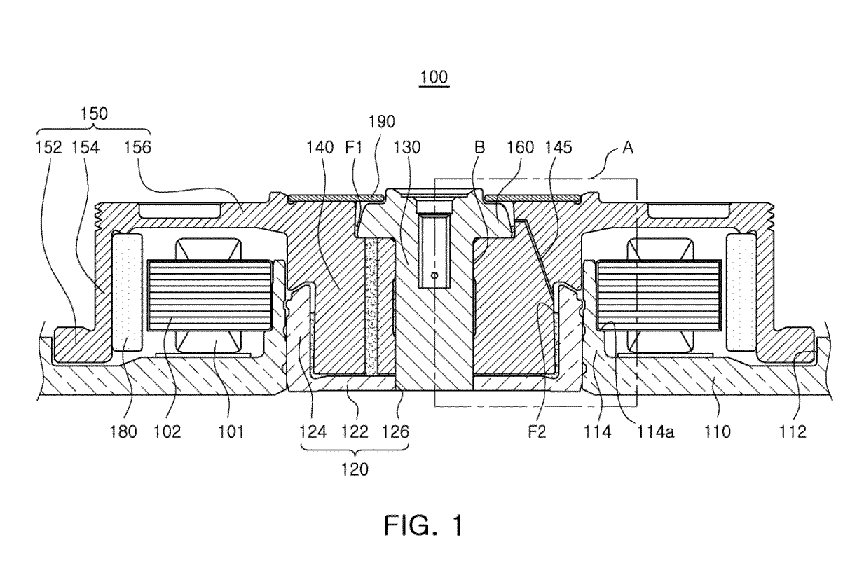

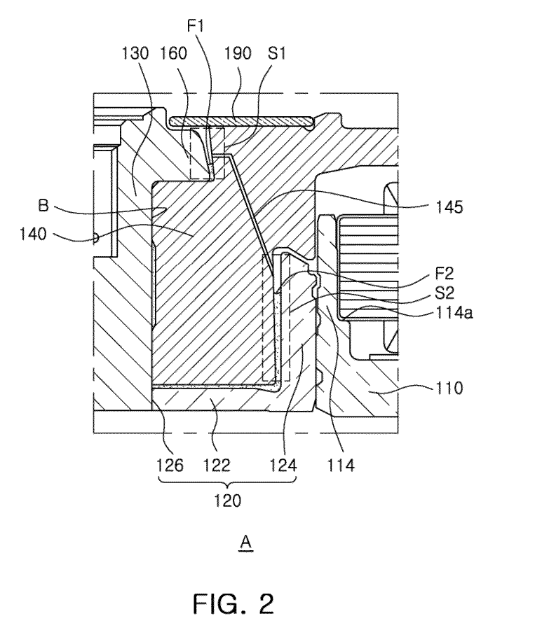

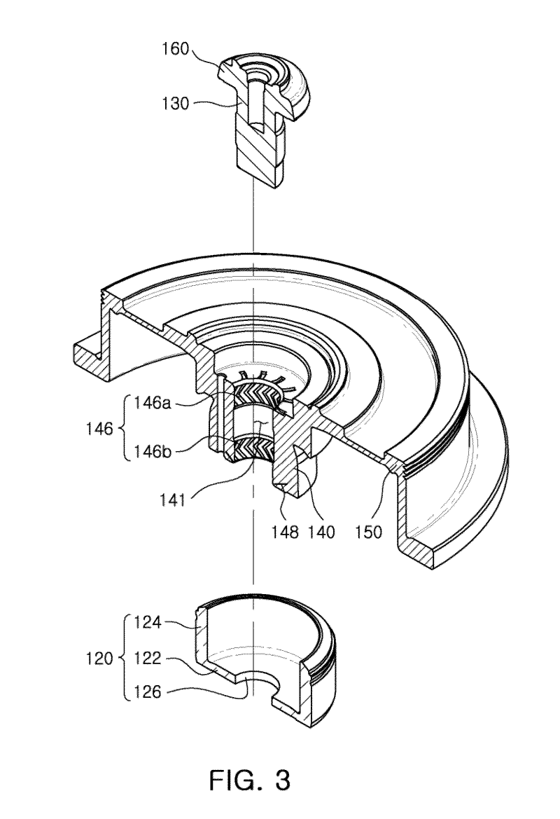

FIG. 1 is a schematic cross-sectional view illustrating a spindle motor according to an exemplary embodiment of the present disclosure; FIG. 2 is an enlarged view of part A of FIG. 1; and FIG. 3 is a partially cut-away exploded perspective view illustrating a shaft, a sleeve, and upper and lower thrust members according to an exemplary embodiment of the present disclosure.

Referring to FIGS. 1 through 3, a spindle motor 100 according to an exemplary embodiment of the present disclosure may include a base member 110, a lower thrust member 120, a shaft 130, a rotating member having a sleeve 140 and a rotor hub 150 formed integrally with each other, and an upper thrust member 160. In addition, the spindle motor 100 according to an exemplary embodiment of the present disclosure may further include a cap member 190 mounted on the rotor hub 150 so as to finish an upper sealing part.

Here, terms with respect to directions will first be defined. As viewed in FIG. 1, an axial direction refers to a vertical direction, that is, a direction from a lower portion of the shaft 130 toward an upper portion thereof or a direction from the upper portion of the shaft 130 toward the lower portion thereof, a radial direction refers to a horizontal direction, that is, a direction from the shaft 130 toward an outer peripheral surface of the rotor hub 150 or from the outer peripheral surface of the rotor hub 150 toward the shaft 130, and a circumferential direction refers to a rotation direction along a predetermined radius at the center of rotation.

In addition, the lower thrust member 120 may be included, together with the base member 110, in a fixed member, that is, a stator.

The base member 110 may include a mounting groove 112 formed therein so as to form a predetermined space together with the rotor hub 150. In addition, the base member 110 may have a coupling part 114 extended upwardly in the axial direction and having a stator core 102 installed on an outer peripheral surface thereof.

In addition, the coupling part 114 may have a seating surface 114a provided on the outer peripheral surface thereof so that the stator core 102 may be seated and installed thereon. Further, the stator core 102 seated on the coupling part 114 may be disposed above the mounting groove 112 of the base member 110 described above.

Here, the base member 110 may be manufactured by die-casting aluminum (Al) or be manufactured by performing plastic working (for example, press working) on a steel sheet.

The lower thrust member 120 may be fixed to the base member 110. That is, the lower thrust member 120 may be inserted into the coupling part 114. In more detail, the lower thrust member 120 may be installed so that an outer peripheral surface thereof is bonded to an inner peripheral surface of the coupling part 114.

Meanwhile, the lower thrust member 120 may include a disk part 122 and an extension part 124 extended from an outer edge of the disk part 122 in the upward axial direction and having an outer surface fixed to the base member 110. In addition, the disk part 122 may have a mounting hole 126 formed in the center thereof so as to penetrate therethrough in the axial direction, wherein the mounting hole 126 has a lower end of a shaft 130 to be described below fitted thereinto.

That is, the lower thrust member 120 may have a cup shape in which it has a hollow part and includes the mounting hole 126 into which the shaft 130 is fitted at the center of the hollow part. In other words, the lower thrust member 120 may have an [symbol] shaped cross section.

Meanwhile, the lower thrust member 120 according to the present exemplary embodiment may have a thrust bearing surface 121 positioned on an upper surface of the disk part 122 and forming a thrust bearing between the thrust bearing surface 121 and a lower surface of the sleeve 140.

The shaft 130 may be fixed to the lower thrust member 120. That is, the lower end of the shaft 130 may be fitted into the mounting hole 126 formed in the lower thrust member 120, such that the shaft 130 may be firmly fixed to the lower thrust member 120. That is, the lower end portion of the shaft 130 in the axial direction may be fitted into the mounting hole 126 of the lower thrust member 120. As a coupling method, various coupling methods such as an adhesive bonding method, a slide coupling method, a screw fastening method, a press-fitting method, and the like, may be used.

Although the case in which the shaft 130 is fixed to the lower thrust member 120 has been described by way of example in the present exemplary embodiment, the present disclosure is not limited thereto. For example, in the case in which the lower thrust member 120 is formed integrally with the base member 110, the shaft 130 may also be fixed to the base member 110.

Meanwhile, the shaft 130 may also be included, together with the lower thrust member 120 and the base member 110, in the fixed member, that is, the stator.

An upper surface of the shaft 130 may be provided with a coupling unit, for example, a screw part having a screw attached thereto, so that a cover member (not shown) may be fixed thereto.

The rotating member may be provided by forming the sleeve 140 and the rotor hub 150 integrally with each other. Hereinafter, for convenience, the sleeve 140 and the rotor hub 150 will hereinafter be separately described in detail.

The sleeve 140 may be rotatably installed on the shaft 130. To this end, the sleeve 140 may include a through-hole 141 into which the shaft 130 is inserted. Meanwhile, in the case in which the sleeve 140 is rotatably installed on the shaft 130, an inner peripheral surface of the sleeve 140 and an outer peripheral surface of the shaft 130 may be disposed so as to be spaced apart from each other by a predetermined interval to form a bearing clearance B therebetween. In addition, the bearing clearance B may be filled with a lubricating fluid.

In addition, the sleeve 140 may have the rotor hub 150 formed integrally therewith on an outer peripheral surface thereof. In the case in which the sleeve 140 and the rotor hub 150 are formed integrally with each other, since both the sleeve 140 and the rotor hub 150 are provided as a single member, the number of components may be decreased, whereby a product may be easily assembled.

Meanwhile, a lower end portion of the outer peripheral surface of the sleeve 140 may be inclined upwardly in an inner diameter direction so as to form a liquid-vapor interface together with the extension part 124 of the lower thrust member 120.

That is, the lower end portion of the sleeve 140 may be inclined upwardly in the inner diameter direction so that a second liquid-vapor interface F2 may be formed in a space between the outer peripheral surface of the sleeve 140 and the extension part 124 of the lower thrust member 120. In addition, the outer peripheral surface of the sleeve 140 and the extension part 124 of the lower thrust member 120 may have a second sealing part S2 formed therebetween, wherein the second sealing part S2 has the second liquid-vapor interface F2 formed therein.

As described above, since the second liquid-vapor interface F2 is formed in the space between the lower end portion of the sleeve 140 and the extension part 124, the lubricating fluid filled in the bearing clearance B may form a first liquid-vapor interface F1 to be described below and the second liquid-vapor interface F2.

In addition, the sleeve 140 may have a radial dynamic pressure groove 146 formed in an inner surface thereof in order to generate fluid dynamic pressure in the lubricating fluid provided in the bearing clearance B at the time of being rotated. That is, the radial dynamic pressure groove 146 may include upper and lower radial dynamic pressure grooves 146a and 146b, as shown in FIG. 3.

However, the radial dynamic pressure groove 146 is not limited to being formed in the inner surface of the sleeve 140, but may also be formed in the outer peripheral surface of the shaft 130. In addition, the radial dynamic pressure groove 146 may have various shapes such as a herringbone shape, a spiral shape, a screw shape, and the like.

The rotor hub 150 may be coupled integrally with the sleeve 140 to thereby be rotated together with the sleeve 140.

The rotor hub 150 may include a rotor hub body 156, a mounting part 154 extended from an edge of the rotor hub body 156 and including a magnet 180 mounted on an inner surface thereof, and an extension part 152 extended from an edge of the mounting part 154 in an outer diameter direction.

Meanwhile, a lower end portion of an inner surface of the rotor hub body 156 may be bonded to an outer surface of the sleeve 140. That is, the lower end portion of the inner surface of the rotor hub body 156 and a bonding surface 145 of the sleeve 140 may be coupled to each other in a press-fitting or slide coupling scheme or may be bonded to each other by an adhesive and/or welding.

Therefore, the sleeve 140 may be rotated together with the rotor hub 150 at the time of rotating the rotor hub 150.

In addition, the mounting part 154 may be extended from the rotor hub body 156 in downwardly in the axial direction. Further, the mounting part 154 may have the magnet 180 fixedly installed on the inner surface thereof.

The magnet 180 may have an annular ring shape and be a permanent magnet generating a magnetic field having a predetermined strength by alternately magnetizing an N pole and an S pole in the circumferential direction.

Meanwhile, the magnet 180 may be disposed to face a front end of the stator core 102 having a coil 101 wound therearound and generate driving force capable of rotating the rotor hub 150 through electromagnetic interaction with the stator core 102 having the coil 101 wound therearound.

That is, when power is supplied to the coil 101, driving force capable of rotating the rotor hub 150 may be generated by the electromagnetic interaction between the stator core 102 having the coil 101 wound therearound and the magnet 180 disposed to face the stator core 102, such that the rotor hub 150 may be rotated together with the sleeve 140.

The upper thrust member 160 may be fixed to an upper end portion of the shaft 130 and may have an outer surface forming the first liquid-vapor interface F1 together with an inner surface of the rotor hub 150 in the radial direction. That is, the outer surface of the upper thrust member 160 and the inner surface of the rotor hub 150 may have a first sealing part S1 formed therebetween, wherein the first sealing part S1 has the first liquid-vapor interface F1 formed therein.

Therefore, the outer surface of the upper thrust member 160 may be inclined in the outer diameter direction downwardly in the axial direction. Here, the upper thrust member 160 may be formed integrally with the shaft 130.

The upper thrust member 160 may be disposed in a space formed by an upper end portion of the outer peripheral surface of the shaft 130, an upper surface of the sleeve 140, and the inner surface of the rotor hub 150.

In addition, the upper thrust member 160, also a fixed member fixedly installed together with the base member 110, the lower thrust member 120, and the shaft 130, may configure the stator.

Meanwhile, a thrust dynamic groove 148 for generating thrust dynamic pressure may be formed in at least one of a lower surface of the upper thrust member 160 and the upper surface of the sleeve 140 disposed to face the lower surface of the upper thrust member 160.

In addition, the upper thrust member 160 may have the cap member 190 formed thereon so as to prevent the lubricating fluid provided in the bearing clearance B from leaking upwardly, wherein the cap member 190 may be mounted on the rotor hub 150.

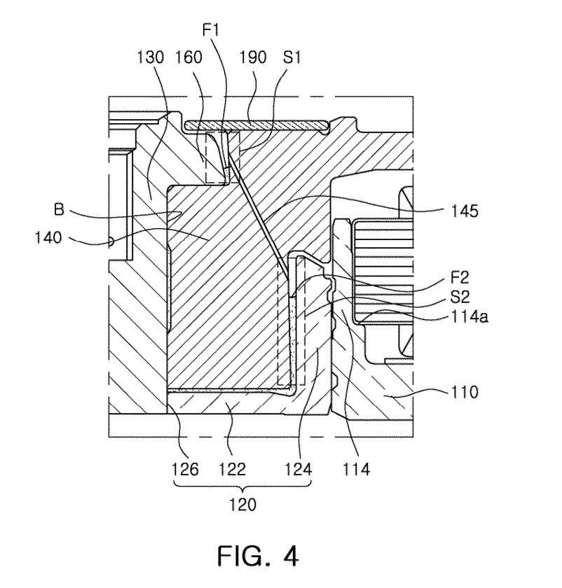

FIG. 2 is an enlarged view of part A of FIG. 1; and FIG. 4 is an enlarged view of another example of part A of FIG. 1.

As shown in FIGS. 2 and 4, the spindle motor 100 according to an exemplary embodiment of the present disclosure may include a communication hole 145 formed in the rotating member and allowing the first sealing part S1 disposed at an upper portion and the second sealing part S2 disposed at a lower portion to be in communication with each other.

Since the communication hole 145 is formed, oil that may be leaked from the first sealing part S1 to the outside may move to the second sealing part S2 along the communication hole 145, such that an amount of fluid that may be leaked upwardly may be significantly decreased.

Meanwhile, when a size of the communication hole 145 is increased, it may have an effect on rotation of the rotating member. However, since the communication hole 145 is formed at a very small size, a fluid does not easily flow in an inner portion, but may flow in the outer diameter direction by centrifugal force by rotation of the rotating member.

Therefore, the second sealing part S2 may be positioned at an outer side in the radial direction as compared with the first sealing part S1.

Meanwhile, at least a portion of the communication hole 145 may be inclined in the outer diameter direction toward the downward axial direction. In more detail, the communication hole 145 may include a horizontal portion extended from a portion that is in communication with the first sealing part S1 in the outer diameter direction and an inclined part that is in communication with the second sealing part S2 from an outer edge of the horizontal portion in the radial direction and inclined in the outer diameter direction downwardly in the axial direction.

In addition, in a state in which the rotating member stops, an inner edge of the communication hole 145 in the radial direction may be positioned above the first liquid-vapor interface F1 in the axial direction, and an outer edge of the communication hole 145 in the radial direction may be positioned above the second liquid-vapor interface F2 in the axial direction.

Further, an inner surface of the rotating member in the radial direction forming the first sealing part S1 may be inclined in the inner diameter direction upwardly in the axial direction. Therefore, in the case in which the lubricating fluid goes up along the inner surface of the rotating member in the radial direction in the upward axial direction so as to be leaked, the lubricating fluid may be easily sucked into the communication hole 145.

Further, an outer surface of the upper thrust member 160 in the radial direction forming the first sealing part S1 may be inclined in the inner diameter direction upwardly in the axial direction, such that an interval between the outer surface of the upper thrust member 160 in the radial direction and the inner surface of the rotating member facing the outer surface of the upper thrust member 160 in the radial direction may be reduced downwardly in the axial direction. Therefore, capillary force may be increased, such that sealing force of the first liquid-vapor interface F1 may be improved.

In addition, an outer surface of the rotating member in the radial direction forming the second sealing part S2 may be inclined in the inner diameter direction upwardly in the axial direction, such that an interval between the outer surface of the rotating member in the radial direction and an inner surface of the extension part 124 of the lower thrust member 120 facing the outer surface of the rotating member in the radial direction may be reduced downwardly in the axial direction. Therefore, capillary force may be increased, such that sealing force of the second liquid-vapor interface F2 may be improved.

In addition, the communication hole 145 may be formed in the radial direction.

Further, a lower end of the first sealing part may be positioned above the second sealing part in the axial direction.

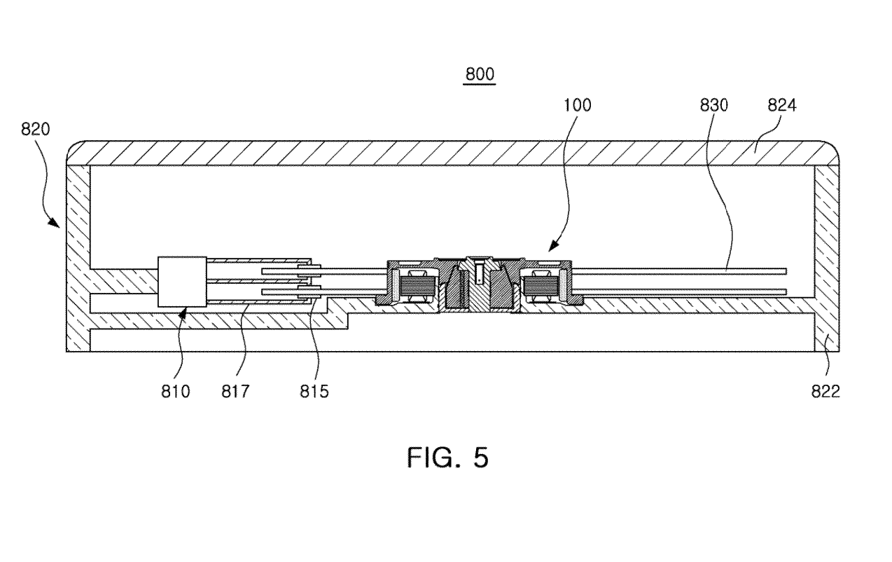

FIG. 5 is a schematic cross-sectional view illustrating a recording disk driving device having the spindle motor according to an exemplary embodiment of the present disclosure mounted therein.

Referring to FIG. 5, a recording disk driving device 800 having the spindle motor 100 according to an exemplary embodiment of the present disclosure mounted therein may be a hard disk drive and may include the spindle motor 100, a head transfer part 810, and a housing 820.

The spindle motor 100 may have all features of the spindle motor according to an exemplary embodiment of the present disclosure described above and have a recording disk 830 mounted thereon.

The head transfer part 810 may transfer a magnetic head 815 detecting information of the recording disk 830 mounted in the spindle motor 100 to a surface of the recording disk of which the information is to be detected.

Here, the magnetic head 815 may be disposed on a support part 817 of the head transfer part 810.

The housing 820 may include a motor mounting plate 822 and a top cover 824 shielding an upper portion of the motor mounting plate 822 in order to form an internal space accommodating the spindle motor 100 and the head transfer part 810 therein.

As set forth above, according to exemplary embodiments of the present disclosure, a phenomenon that a lubricating fluid is leaked toward an upper interface may be effectively prevented by a simple structural change.

While exemplary embodiments have been shown and described above, it will be apparent to those skilled in the art that modifications and variations could be made without departing from the scope of the present invention as defined by the appended claims.

What is claimed is:

1. A spindle motor comprising:
a lower thrust member fixed to a base member and including an extension part protruding upwardly in an axial direction;
a shaft fixed to the lower thrust member;
an upper thrust member extended from an upper end portion of the shaft in a radial direction; and
a rotating member disposed above the lower thrust member and rotatably installed on the shaft,
wherein an outer surface of the upper thrust member and an inner surface of the rotating member have a first sealing part formed therebetween in the radial direction, the first sealing part having a first liquid-vapor interface formed therein,
an inner surface of the extension part of the lower thrust member and an outer surface of the rotating member have a second sealing part formed therebetween in the radial direction, the second sealing part having a second liquid-vapor interface formed therein, and
the rotating member includes a communication hole formed therein so as to connect the first and second sealing parts to each other.

2. The spindle motor of claim 1, wherein at least a portion of the communication hole is inclined in an outer diameter direction downwardly in the axial direction.

3. The spindle motor of claim 1, wherein the communication hole includes a horizontal portion extended from a portion that is in communication with the first sealing part in an outer diameter direction and an inclined part that is in communication with the second sealing part from an outer edge of the horizontal portion in the radial direction and inclined in the outer diameter direction downwardly in the axial direction.

4. The spindle motor of claim 1, wherein in a state in which the rotating member stops, an inner edge of the communication hole in the radial direction is positioned above the first liquid-vapor interface in the axial direction, and an outer edge of the communication hole in the radial direction is positioned above the second liquid-vapor interface in the axial direction.

5. The spindle motor of claim 1, wherein the inner surface of the rotating member in the radial direction forming the first sealing part is inclined in an inner diameter direction upwardly in the axial direction.

6. The spindle motor of claim 1, wherein the outer surface of the upper thrust member in the radial direction forming the first sealing part is inclined in an inner diameter direction upwardly in the axial direction.

7. The spindle motor of claim 1, wherein the outer surface of the rotating member in the radial direction forming the second sealing part is inclined in an inner diameter direction upwardly in the axial direction.

8. The spindle motor of claim 1, wherein an interval between the inner surface of the rotating member in the radial direction and the outer surface of the upper thrust member in the radial direction that form the first sealing part becomes small downwardly in the axial direction.

9. The spindle motor of claim 1, wherein an interval between the outer surface of the rotating member in the radial direction and the inner surface of the extension part in the radial direction that form the second sealing part becomes small downwardly in the axial direction.

10. The spindle motor of claim 1, wherein the communication hole is formed in the radial direction.

11. The spindle motor of claim 1, wherein a lower end of the first sealing part is positioned above the second sealing part in the axial direction.

12. The spindle motor of claim 1, wherein the second sealing part is positioned at an outer side in the radial direction as compared with the first sealing part.

13. A hard disk drive comprising:
the spindle motor of claim 1 rotating a disk through power applied thereto through a substrate;
a magnetic head writing data to and reading data from the disk; and
a head transfer part moving the magnetic head to a predetermined position on the disk.
